(19) United States
(12) Patent Application Publication
(10) Pub. No.: US 2026/0268476 A1
(43) Pub. Date: Sep. 10, 2026

(54) Method, Computer-Readable Media and Control Device

(71) Applicant: CI Tech Sensors AG, Burgdorf (CH)

(72) Inventors: Alexander Lampe, Burgdorf (CH); Roman Held, Burgdorf (CH); Harald Ammeter, Burgdorf (CH); Christian Schmied, Burgdorf (CH); Armin L. Stoeckli, Ittigen (CH)

(21) Appl. No.: 19/168,077

(22) PCT Filed: Mar. 22, 2024
(86) PCT No.: PCT/EP2024/057781

§ 371 Date: Sep. 23, 2025

(30) Foreign Application Priority Data
Mar. 24, 2023 (EP) 23164179.6

(51) Int. Cl. G06T 7/00; G06T 7/73; G06V 10/764; G06V 30/42

(52) U.S. Cl. CPC G06T 7/001; G06T 7/74; G06T 2207/10024; G06T 2207/30144; G06V 10/764; G06V 30/42

(57) ABSTRACT

According to various aspects, method (300), comprising: determining (201) two or more graphical patterns of a graphical reference layout (102), which fulfill a criterion for a printing related positional variation (d) relative to each other, based on multiple printed reproductions (114) of the graphical reference layout (102); determining (205) a model (250) of the graphical reference layout (102) based on a result of the determining (201) the two or more graphical patterns, wherein the model implements, for each graphical pattern of the two or more graphical patterns, a representation (250a, 250b, 250c) of the graphical reference layout (102), by which at least a part of the graphical pattern is masked or at least marked.

Various aspects relate generally to a method, computer-readable media, and a control device.

Generally, banknotes are used worldwide for financial transactions, and thus are circulating through various instances, such as banking terminals, stores, safes, wallets, and the like. During circulation, the condition of a banknote may deteriorate, e.g., due to mechanical load and/or contamination. Therefore, some of the instances are used to check the fitness of the banknote for further usage, and if necessary, remove them from circulation. One challenge in this context includes the distinction of various contaminations, such as stain-and graffiti, from the potentially complex pattern of the banknote.

Throughout the drawings, it should be noted that like reference numbers are used to depict the same or similar elements, features, and structures. The drawings are not necessarily to scale, emphasis instead generally being placed upon illustrating aspects of the disclosure. In the following description, some aspects of the disclosure are described with reference to the following drawings, in which:

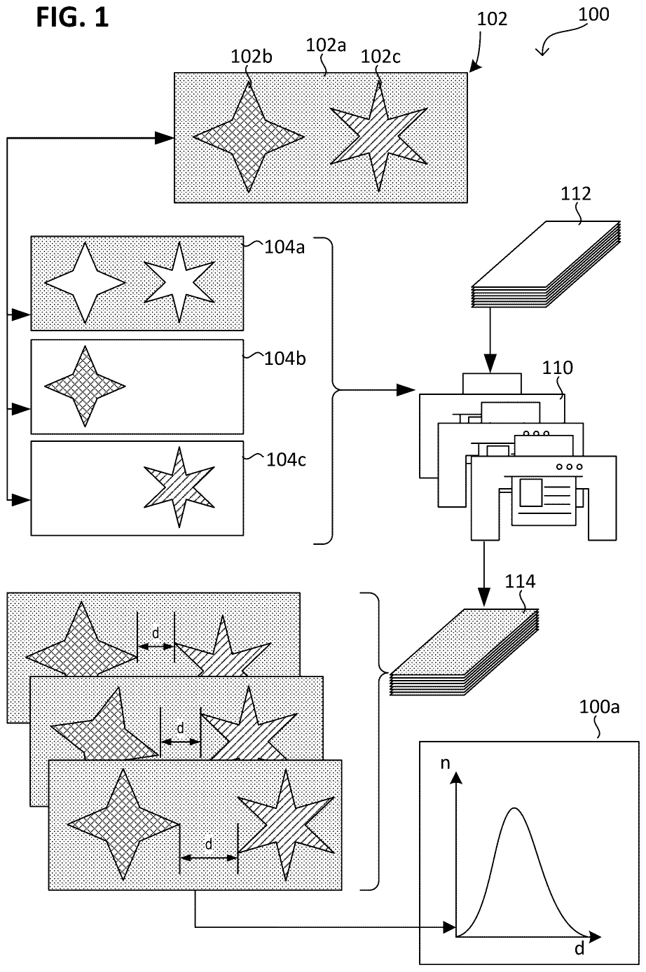

FIG. 1 shows a schematic diagram of a printing process according to various aspects;

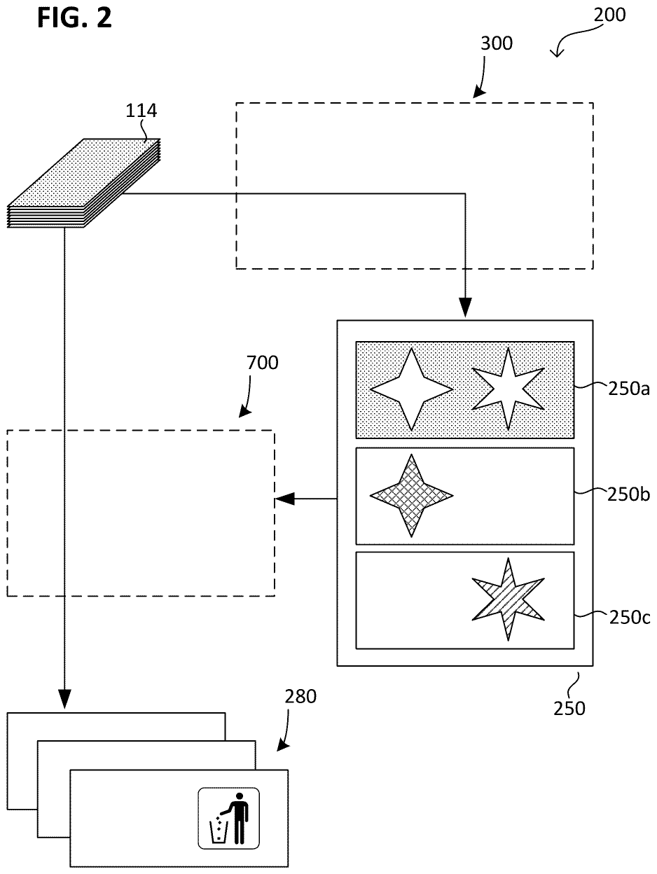

FIGS. 2, 3 and 7 show each a schematic diagrams of multiple methods according to various aspects;

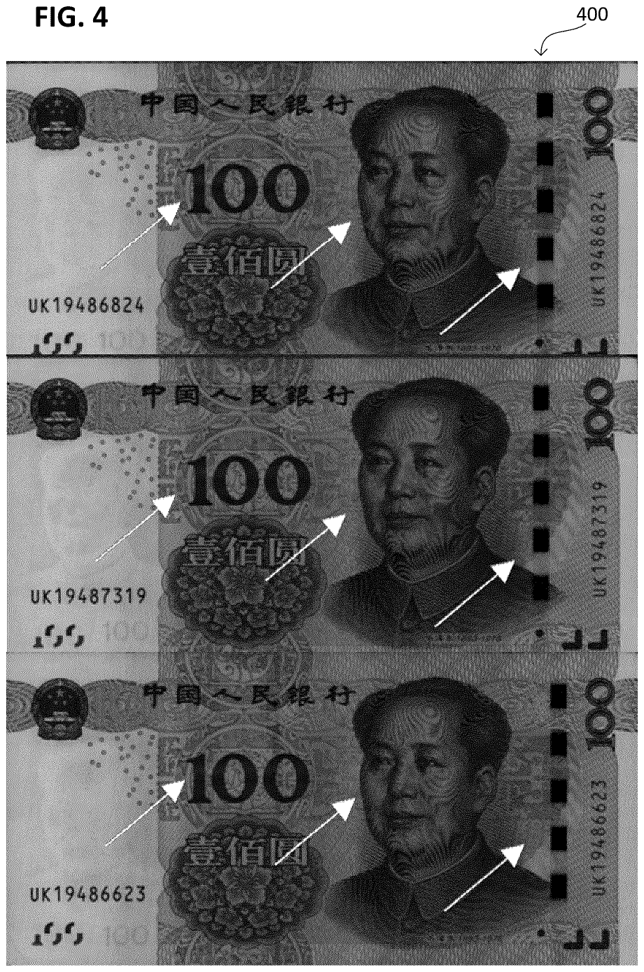

FIG. 4 show each a schematic view of image data of multiple banknotes according to various aspects;

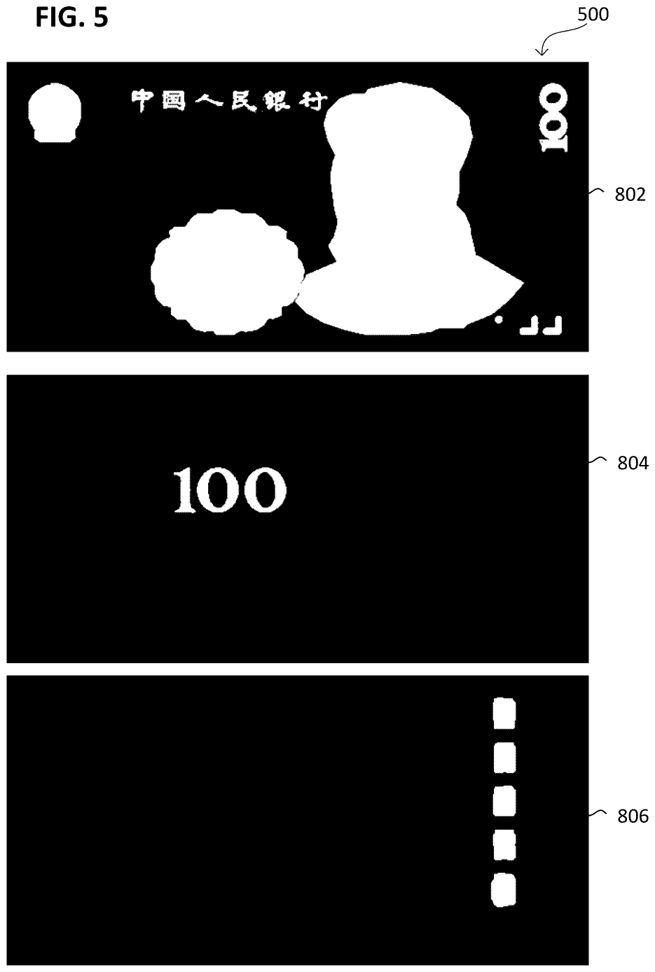

FIG. 5 shows a schematic view of multiple image processing masks according to various aspects;

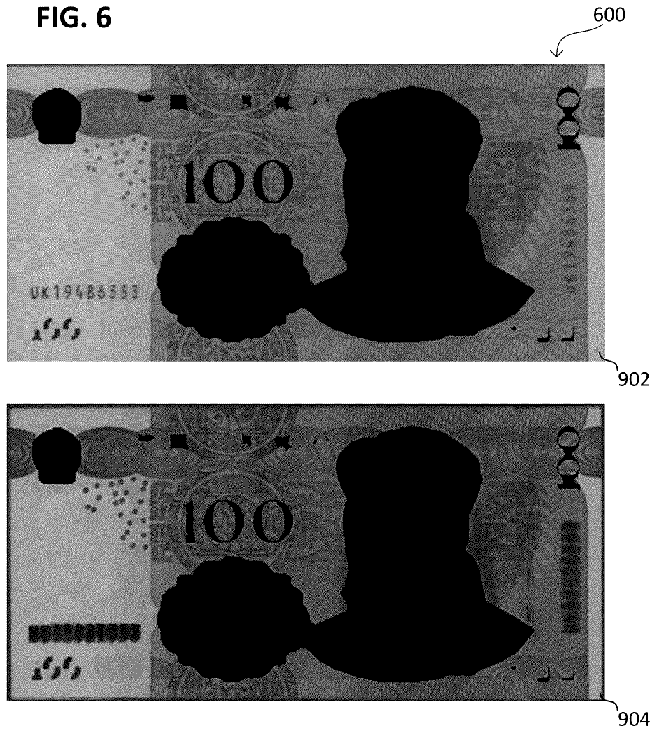

FIG. 6 shows a schematic view of two exemplary results of masking the positional-normalized banknote image according to various aspects;

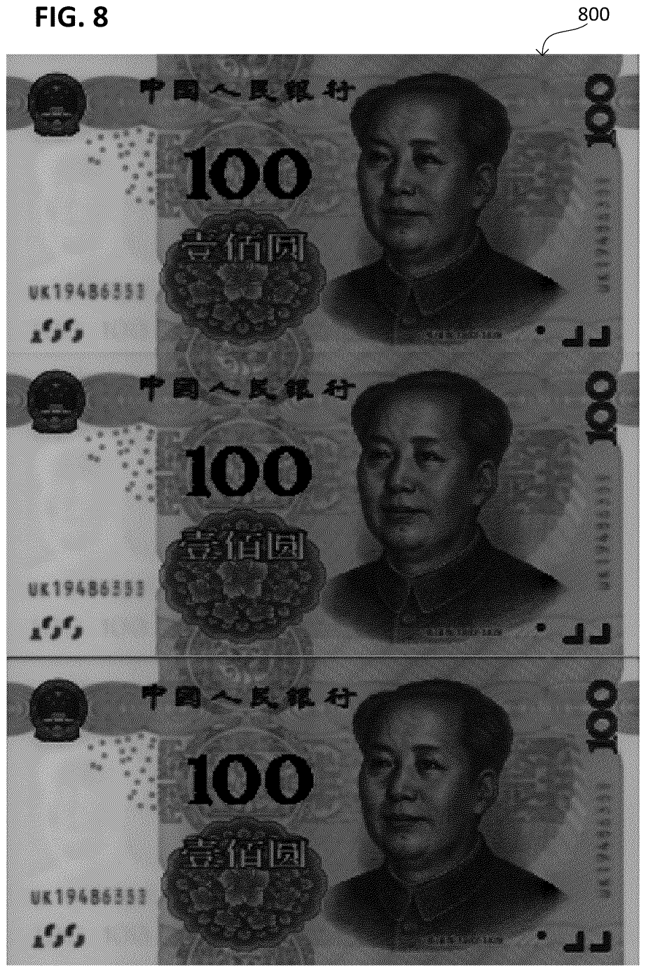

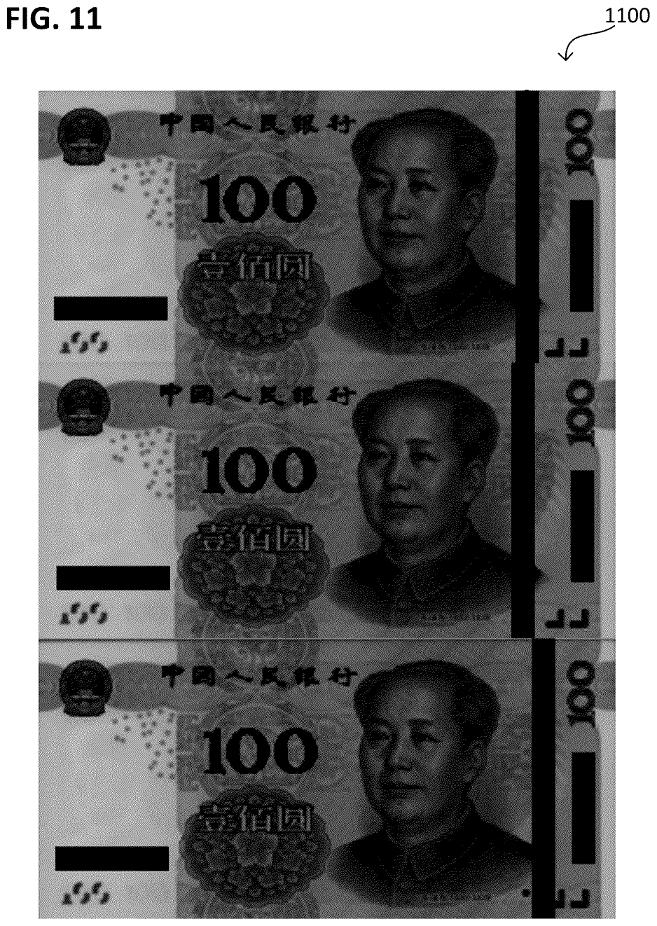

FIGS. 8 and 11 show each a schematic view of multiple banknote models according to various aspects;

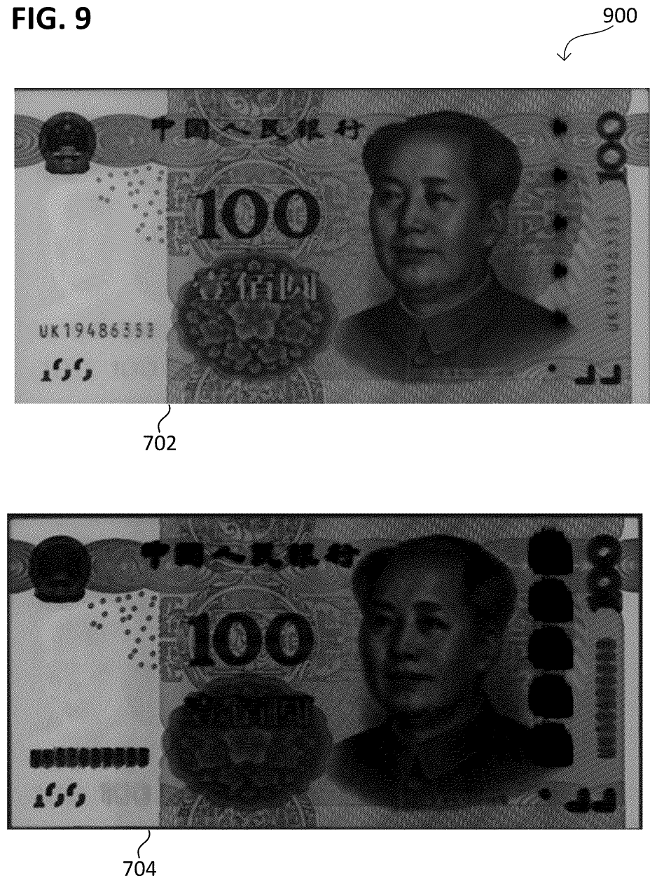

FIG. 9 shows a schematic view of a superposition according to various aspects; and

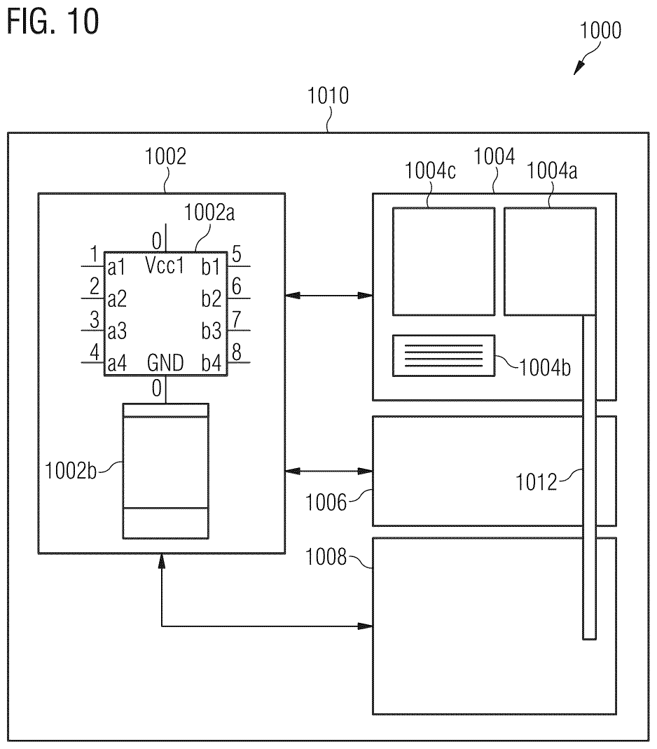

FIG. 10 shows a schematic view of a banking terminal according to various aspects.

The following detailed description refers to the accompanying drawings that show, by way of illustration, specific details and aspects in which the disclosure may be practiced. One or more aspects are described in sufficient detail to enable those skilled in the art to practice the disclosure. Other aspects may be utilized and structural, logical, and electrical changes may be made without departing from the scope of the disclosure. The various aspects are not necessarily mutually exclusive, as some aspects can be combined with one or more other aspects to form new aspects. Various aspects are described in connection with methods and various aspects are described in connection with devices. However, it may be understood that aspects described in connection with methods may similarly apply to the devices, and vice versa. Throughout the drawings, it should be noted that like reference numbers are used to depict the same or similar elements, features, and structures.

The present disclosure may include various processes (e.g., methods and functions thereof). In some embodiments, the processes may be performed by hardware components or may be embodied in computer-readable instructions, which may be used to cause a general purpose or special purpose processor or logic circuits programmed with the instructions to perform the processes. Alternatively, the processes may be performed by a combination of hardware and software. According to various aspects, one or more processes performed by one or more processors may, illustratively as counterpart, be realized by code segments stored in the memory, wherein, the code segments cause, if executed by the one or more processors, the one or more processors to perform the processes (e.g., functions and methods). The code segments, e.g., provided as part of the software, may be updated via a (e.g., mobile) network, e.g., on demand.

The term “processor” as, for example, used herein may be understood herein as any kind of entity that allows handling data, signals, as examples. The data, signals, as example, may be handled according to one or more specific functions executed by the processor. A processor may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), as examples, or any combination thereof. Any other kind of implementation of the respective functions, which will be described below in further detail, may also be understood as a processor or logic circuit. It is understood that any two (or more) of the processors or logic circuits detailed herein may be realized as a single entity with equivalent functionality, and conversely that any single processor or logic circuit detailed herein may be realized as two (or more) separate entities with equivalent functionality. It is understood that one or more of the method steps detailed herein may be performed (e.g., realized) by a processor, may by one or more specific functions executed by the processor.

The term “control device” (also referred as to controller) may be understood herein as referring to any kind of a logic implementing entity, which may be implemented by a one or more processors (e.g., including a special purpose circuitry) executing software stored in a memory, firmware, or any combination thereof. Thus, a “control device” may include a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “control device” may, for example, include one or more processors executing software or at least code segments, e.g. any kind of computer program, e.g., a computer program using a virtual machine code such as e.g., Java.

The control device may optionally include a memory, e.g., storing code segments that represent the processes provided by the control device, e.g., the controlling of the one or more operating functions. Additionally or alternatively, the memory may store one or more criterion, rules, and algorithms, as examples, as detailed herein.

As used herein, “memory” may be understood herein as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, as examples, or any combination thereof. Furthermore, it is appreciated that registers, shift registers, processor registers, data buffers, as examples, are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

Reference is made to “image data” and processing of image data. Image data may be the result of sensing the reality (e.g., of an object) optically (also referred to as imaging process or shortly imaging), and thus may be regarded as a digital representation of the reality, e.g., its current state at the point of time when the image data is obtained. For example, the imaging process may include projecting light (e.g., by an optical system, e.g., including one or more lenses and/or one or more mirrors) onto the surface of an image sensor (e.g., a Bayer sensor) and reading out the image sensor. The image data as read-out from the image sensor may be raw image data (also referred to as RAW), including information about the light as sensed by the image sensor, e.g., pixel by pixel (also referred to as raster graphic). The image data may optionally be converted (e.g., prior or during) processing into an image format type different from RAW, e.g. into raster graphic of another type than RAW, or a vector graphic, so that their further processing may be based on this image format, or may be converted arbitrarily between different image formats. The conversation may optionally include interpolating (e.g., using demosaicking) the data as read-out from the image sensor, e.g., to obtain complete multicolor color information for each pixel or to use less memory or processing power. The image data may optionally be compressed (e.g., to require less storage space or computing power) or uncompressed (e.g., to avoid distortion). The respective image format, in which the image data is provided, may further define the color model, according to which the color information of the image data is specified. For example, the image data may be expressed as coordinates in a color space based on the color model.

The simplest case is a binary color space, according to which the value of one bit (e.g., representing a black-white value) is provided per pixel. In a more complex color space, e.g., grayscale color model, the colors of the color space are identified together with their intensity level, e.g., providing multiple levels between black and white (also called gray values) per pixel. However, the color model may also be defined by multiple (e.g. two or more) basic colors, such as red, green and blue. For example, a wavelength-sensitive image sensor may be used to obtain image data including multicolor information. The respective light properties may be expressed in accordance with the used color model. It may be understood that the references made herein regarding image data or color model may apply analogously to multicolor (also referred to as polychrome) or monochrome color model. A display device may be used for graphical reproduction of the image data on the display device. For such graphical reproduction, the image data is converted by a graphic processor into control signals for controlling the display device. For ease of understanding, the image data as referred herein is depicted as graphical reproduction of the image data, but may be processed any image format type, e.g., as bit string. For example, the image data, e.g., stored in a storage medium, may include a bit string, e.g., stored in a file (also referred to as a digital image or image file) according to the particular image format type.

An imaging device may be understood herein as device, by which the imaging process may be performed. For example, the imaging device may include the image sensor, optionally the optical system, and a data interface for providing the read-out image data. The term “type” in context to a device (e.g., the imaging device) may be understood herein as referring to the construction (also referred to as constructional type), which is the same for all devices of the same type (e.g., of the same production series). For example, two imaging devices of the same type match in their constructional attributes (e.g., their architecture), e.g., of their image sensor (e.g., the pixel density thereof, total pixel amount thereof, the size thereof, technology, etc.), of their optical system (also referred to as photographic objective) and/or of their data interface. For example, two imaging devices of the same type match in one or more (e.g., each) of the following sensory properties, e.g., sensory non-uniformity (photo response non-uniformity), signal-to-noise ratio, resolution, pixel density (e.g., pixel per inch), etc. Analogously, image data (and processing results based thereon), which are sensed by two imaging devices of the same type match one or more (e.g., each) of the following image properties: e.g., sensory non-uniformity (photo response non-uniformity), signal-to-noise ratio, resolution, pixel density (e.g., pixel per inch).

The term “banking terminal” may be understood herein as referring to any device including an interface (e.g., human-machine-interface) for interacting with a human and being capable of performing a one or more banking transactions in response to the interaction with the human, e.g., in response to being instructed by the human. Examples of the banking transaction may include: receiving cash from the human, dispensing cash to the human, financial transfer from or to an account of the human (e.g., a payment or a financial transfer from account to account).

The term “cash” may be understood herein as referring to any (e.g., physical) medium of financial exchange, for example banknotes and coins. The term “banknote” may be understood herein as referring to any negotiable promissory note (e.g., certificate), e.g., made by a bank or other licensed authority, e.g., payable to the bearer on demand. In particular, reference is made herein to a banknote in the form of printed matter (e.g., sheet), e.g., a printed paper, a printed fabric or a printed polymer sheet. The term “currency” may be understood herein as referring to the financial system and its metrics, for which the cash is used as medium of financial exchange.

The term “printing” may be understood herein as referring to any process (also referred to as printing process) of reproducing a graphical reference layout by transferring a colorant (also referred to as stain) to a surface to be printed, e.g., of a paper, of a fabric or of a polymer sheet. The term “colorant” may be understood herein as any substance being capable of (e.g., permanently) changing the color (e.g., color) of a surface when being applied to the surface. Examples of the colorant include ink, dye, paint, pigments, etc. Examples of the printing process include intaglio printing, offset printing, inkjet printing, laser printing, relief printing, screen printing, etc.

The graphical reference layout (in context to printing also referred to as printing template) may be provided in any digital or analog form and may include one or more graphical patterns (also referred to as layout component), e.g., in the form of typographic glyphs (e.g., one or more numbers and/or one or more letters) and/or decorative elements (e.g., an ornament and/or a scene). The term “printed matter” may be understood herein as referring to the physical result of the printing process, e.g., including a printed version of the graphical reference layout (also referred to as printed reproduction thereof, as print exemplar thereof, or as printout). Various examples of the graphical reference layout (also referred to as reference graphic) indicate the arrangement (e.g., positional relation, size, etc.) of multiple graphical patterns to be printed. The graphical reference layout for a banknote may include one or more of the following graphical pattern: a graphical background; a graphical representation of a denomination; a graphical security feature; an identification number; a pictorial element. The term pictorial element may include all types of (e.g., decorative, e.g., non-functional) elements (e.g., pictures or parts thereof), which are not necessarily functional (e.g., for identification, security, denomination, or the like). Examples of pictorial elements may include portraits, landscapes, ornaments, drawings, buildings, and the like.

The term “multi-stage” printing process may be understood herein as referring to any (e.g., analog) printing process, which uses multiple colorants and includes, for each of the multiple colorants, a stage (also referred to as printing process stage) configured to transfer the colorant to the surface. In various examples, the configuration of the multi-stage printing process (e.g., number of stages, specific colorants, etc.) is correlated to a color model, such as, for example, CMYK color model, which refers to the usage of colorants in cyan, magenta, yellow, and key (black). For example, the multiple colorants may be used to reproduce different colors and/or to individually reproduce graphical patterns (e.g., having one or more colors in common). In various examples, the printing process stages may be applied successively, e.g., to reproduce multiple layout components layer-by-layer.

Correlating to the color space (or the underlying color model), the graphical reference layout may be expressed as superposition of multiple individual components (also referred to as layout component), of which each component is associated with one colorant of the multiple colorants and may by reproduced using a printing process stage, which is configured to transfer the colorant to the surface. Each of the layout components may include one or more graphical pattern of a graphical reference layout and may correlate to a print layer, by which the layout component is reproduced.

In analogy, a multi-stage printing device may be configured to perform a multi-stage printing process. The multi-stage printing device may include, for each printing process stage of the multi-stage printing process, a printing device stage configured to provide the printing process stage, e.g., by adding one print layer on the surface. In various examples, the matter to be printed (e.g., sheets) may be supplied to the printing device stages successively, e.g., transfer the colorants layer-by-layer. The multiple colorants may be transferred to the surface one over the other (also referred to as overprinting), such that their superposition provides a printed reproduction of the graphical reference layout. In various examples, each printing device stage may include a colorant carrier (e.g., a plate or a roll) carrying the colorant in accordance with the printing process stage provided by the printing device stage. Transferring the colorant carried by the colorant carrier to the surface may include pressing the colorant carrier against the surface.

In various examples, the multi-stage printing process may by a multi-type printing process, of which the printing process stages differ from each other in the printing type (e.g., the printing technique). Examples of different printing type include: offset printing, intaglio printing, and/or security features printing.

In order to facilitate the understanding, the result of printing a layout component, e.g., by a printing process stage (e.g., the colorant on the surface as transferred by the printing process stage), is herein also referred to as print layer, wherein the references made thereto may apply analogously to a non-layered printing process. For example, each print layer may include one or more printed graphical patters in accordance with the graphical reference layout. In order to facilitate the understanding, a reference print layer (e.g., the bottommost print layer) of the print layers is referred to as “background print layer”, wherein the subsequent print layers are referred to as “foreground print layer”. In analogy, the corresponding layout components are referred to as “background layout component” or “foreground layout component”, which applies also to the graphical pattern thereof.

The term “position” or “positional” in context with one or more objects (e.g., layout components and/or graphical pattern) may be understood herein as referring to an indication of the location and/or orientation of the one or more objects. A relative position of two objects may be understood herein as referring to an indication of the location (e.g., distance) and/or orientation of two objects relative to each other (e.g., by taking one of the two objects as a reference), e.g., their distance from each other. The location of a spatially extended object may be a function of the location of a reference point of the object, e.g., expressed in coordinates. The orientation of a spatially extended object may be a function of the location of two reference points of the object relative to each other.

Due to variations in the multi-stage printing process (e.g., in alignment variations, device variations, etc.), the position on the surface, at which a graphical pattern of the graphical reference (e.g., a whole layout component) is reproduced by the printing process may vary (also referred to as printing related positional variation) from printout to printout of the graphical reference. For example, two printouts of the same graphical reference may differ from each other in the position, at which the same graphical pattern is reproduced on the surface of the printout. The same applies to the positions, at which two different graphical pattern are reproduced on the surface of the same printout. For example, the distance and/or misalignment of the two or more graphical patterns relative to each other may be used as positional relation of the two or more graphical patterns relative to each other. For a larger number of printouts, the printing related positional variation may be a function of a parameter (e.g., variance and/or dispersion) of the statistical distribution of the positional relation, as example. It may be understood that any other suitable parameter may be used to represent the positional relation.

The term “model” may be understood herein as referring to a data-based (e.g. digital and/or virtual) representation of an original, e.g. a (e.g., physical or virtual) object (e.g. a device) or a process (e.g. a printing process). Determining the model may include determining one or more parameters of the model (also referred to as model parameter), which representing attributes of the original, e.g., by mapping the attributes to the model parameter. To determine the model, the attributes may be abstracted, parameterized, and/or simplified. Examples of attributes being presented by model parameters (also referred to as representation of the property) may include: one or more geometric properties (such as length, distance, volume and/or position, as an examples), weight, volume, composition, color related properties (e.g., expressed as coordinates in a color space), logical information (links, sequence, couplings, interrelationships, dependencies, etc.), time-related information (e.g., time, total duration, frequency, period duration, etc.), and/or functional information (e.g., current, effect, working point space, force, degree of freedom, etc.).

For example, a model of a graphical reference layout may be provided component-wise, e.g., by implementing, for each layout component, a representation of the each layout component. A representation of a layout component may represent one or more geometric properties (such as length, distance, volume and/or position, as an examples) and/or one or more color related properties (e.g., expressed as coordinates in a color space) of the layout component. A representation of a layout component may be provided as a representation of the graphical reference layout, in which one or more graphical pattern, which are not part of the layout component, are masked (e.g., as transparent or as reference color value). The individual representations of the model may be independent from each other, e.g., provided as separate images. Analogously, a model of a printout (e.g., of a banknote) may include a representation of one or more geometric properties (such as length, distance, volume and/or position, as an examples) and/or one or more color related properties (e.g., expressed as coordinates in a color space) of one or more printed graphical pattern (or the whole printed graphical layout) of the printout.

The term “superposition” (in the context of graphics and images also referred to as superimposition) of the two objects (e.g., image data and/or graphical pattern) may be understood herein as referring to the result of superposing the two objects, e.g., an overlay of the two objects. The superposition (e.g., each pixel thereof) may be a (not necessary linear) function of each of the two objects (e.g., the pixel thereof), e.g., in case of a semi-transparent version of one of the two objects overlaying the other of the two objects (also referred to as transparent overlay). An exemplarily superposition of two pixels may include averaging the two pixels, which may be applied to each pixel of the objects. However, other functions may be used to determine the superposition, e.g., if the number of images is more than two. The superposition (e.g., each pixel thereof) may be a (not necessary linear) function of only one of the two objects (e.g., the pixel thereof), e.g., in case of a non-transparent version of one of the two objects overlaying the other of the two objects (also referred to as opaque overlay).

Generally, superposing image data of multiple (e.g., a number of) printouts of the same graphical pattern may reduce granularity and/or reduce printing related variations (e.g., due imperfections and other artifacts). Further, the image sharpness and/or image contrast may be a function of the positional relation of the multiple printouts relative to each other, in which they are superposed. Image sharpness refers to the level of clarity and/or level of detail in an image. When an image is sharp, it has clear, well-defined edges and a high level of detail. When an image is not sharp, it may appear blurry or out of focus.

For example, the image sharpness of the superposition may be increased with a reduction of the positional variation (e.g., by alignment) among the multiple printouts, e.g., above the average sharpness of the multiple printouts. For example, the image sharpness of the resulting superposition may be reduced (by blurring the superposition, e.g., in analogy to motion blur) with an increased positional variation (e.g., by misalignment) among the multiple printouts, e.g., below the average sharpness of the multiple printouts. In some embodiments, the sharpness of the superposition, e.g., the change (incensement or reduction) thereof, may be determined, e.g., relative to a reference sharpness (e.g., the average sharpness).

For example, sharpness may be determined (e.g., parameterized) by determining one or more image parameters (e.g., edge gradient, noise, granularity, and/or contrast, etc.) and/or mapping the one or more image parameters to a sharpness information (e.g., a numeral thereof). Additionally or alternatively, sharpness may be determined (e.g., parameterized) using metrics, such as for example, the Laplacian, Sobel, or Canny edge detection and/or mapping the metrics to the sharpness information (e.g., a numeral thereof). In some embodiments, the sharpness may fulfill a sharpness criterion, e.g., represented by a threshold. For example, the sharpness criterion may be fulfilled, when the sharpness (e.g., the sharpness information) exceeds a threshold and/or when the change of sharpness maintains below a predetermined threshold (e.g., avoiding too much reduction of the sharpness).

The term “masking” may be understood herein to refer to the process of image data manipulation, by which one or more parts of image data are selected (also referred to as masking) according to a masking function. The masking function may be, for example, expressed mathematically (e.g., as part of an algorithm) and/or, as equivalent thereto, in suitable cases expressed by additional image data (in this context, also referred to as image processing mask or short as mask), which may be used as overlay. In an exemplarily implementation, the mask includes a grayscale image, of which the gray values indicate a level of selection. The result of masking may include a (e.g., by a filter) modified version of the image data, in which the one or more parts are marked as selected (also referred to as masked), which, in one or more embodiments, may include filtering the image data in accordance with the masking function (e.g., such that only the one or more parts are filtered). The masking function may be used to isolate a part from the remains of the image data, e.g., by changing the color of the remains.

The term “filtering” may be understood herein to refer to the process of image data manipulation, by which one or more parts of image data are transformed (also referred to as masking) according to a filter function (also referred to as image processing filter), e.g., in terms of color, transparency, and/or geometrics. The filter function may be, for example, expressed mathematically (e.g., as part of an algorithm). As an example, filtering may include setting the one or more parts to black or another reference color value, or to transparent. For example, the masking function indicates (e.g., marks) one or more parts of the image data, which are to be filtered.

In some examples, the masking may include selecting a portion of image data and hide or reveal the portion by applying the mask. In some examples, the masking may be configured to be reversible, e.g., when the original image is still included completely in the result of masking, but does not need to be reversible. For example, the image data may be manipulated pixel by pixel, e.g., by converting each pixel (e.g., to or by a predetermined color space vector) as a function of the coordinates of the pixel. A less complex implementation of masking may include a binary graphical mask, of which a white area indicates an invariant part of the image data and of which a black area indicates a part of the image data, which is set to a common preset color value (e.g., black, white, or another tone).

The term “classifying” (also referred to as classification) an object may be understood herein as referring to the process of assigning the object to one out of multiple predetermined classes. Examples of such classes may include classes for condition (e.g., new, used, battered), classes for contamination (e.g., no, less, medium, heavily), classes for damage (e.g., no, common, heavily damaged), classes for completeness (e.g., complete, incomplete). Some or more classes (also referred to as fitness representing class) detailed herein may represent an acceptable state of the object for further usage, wherein other classes by represent an inacceptable state of the object. For example, in case of a banknote, the banknote may be classified as inacceptable (also referred to as unfit), when being battered and/or heavily contaminated.

The term “predetermined” may be understood herein as indicating one or more of the following properties: invariant, determined in the past, stored (e.g., in computer-readable media), read-out from a computer-readable media, being a constraint, being a boundary condition. For example, a predetermined information used in a process (e.g., method) may be invariant for multiple iterations of the process, may be determined before starting the process, stored in computer-readable media, e.g., in the code segments including instructions according to process, and the like.

In order to facilitate the understanding, e.g., regarding various states as detailed herein, the result of a printing process (e.g., provided as printout) may be indicated by the prefix “printed”, the result of a imaging process (e.g., provided as image data) may be indicated by the prefix “imaged”, and the result of a modeling process (e.g., provided as model) may be indicated by the prefix “modeled”.

In the following detailed description, reference will be made to banknotes as exemplarily printouts. It may be understood that the references made thereto may apply in analogy to other printouts, e.g., other printed cash, postage stamps and the like.

Various aspects are based on the finding that a stain-and graffiti-detection algorithm (SGD) may allow to improve the detectability of stains and graffiti, e.g., especially in the field of printed banknotes. Some SGD use a model of the banknote, which is also referred to as banknote model (BNM). To improve the performance of the SGD, such BNM may be generated individually for each printed banknote under test, which allows to account for the relative position (also referred to as positional relation) of graphical pattern contained in different print layers or security features. Illustratively, such positional relation may vary from banknote to banknote (also referred to as positional variation). To create an individual BNM, e.g. for the (e.g., minimum or mean or median or maximum) expected banknote gray-scale image, following determinations may be made:
Selecting a corresponding background (BG) pattern as BG reference;
Overlaying foreground (FG) patterns as corresponding FG references one after the other over the BG reference as to successively create the BNM. Thereby, the individual position of each FG reference on the BNM may be adjusted according to the estimated positions of their corresponding print layers relative to the background print layer, which may be provided by a so-called anchor-point detection (APD). In general, overlaying the FG pattern may include an intransparent (opaque) overlay or a transparent overlay.
Marking of areas of the BNM, which should be masked completely. Those areas may have an invariant position (such as the banknote border) or a variable position (such as a security thread or serial number).

To enable the overlay of the BG and FG references under a variable positional relation to each other, a background reference for the whole banknote may be provided. Selecting the offset print layer as BG reference as example, could be possible based on the printing plate for the offset print layer. Unfortunately, for many (if not the most) currency systems, the printing plates are not public, why the data representing the individual print layers may be determined (e.g., learned, estimated) based on one or more printed exemplars of the banknote (also referred to as test set).

According to various embodiments, multiple printed banknotes (BN) may be provided as a test-set, of which each BN may be imaged. Based therein a BG reference may be determined, by:
Transforming each imaged BN (also referred to as BN image) into a normalized position (which results in position aligned BN images) such that the offset print layers of all banknotes are aligned
Calculating the desired (e.g. minimum or median) reference by solving for each pixel the desired value from the set of position aligned BN images.

This approach might work for the median reference and/or specific BN designs such as the reverse side of EUR BNs consisting of a single BG print layer. However, for calculation of (e.g. the minimum) BG reference of the front side of EUR BNs, this approach resembling the calculation of statistics notes results in an unsatisfactory BNM. This is due to the movement of FG patterns relative to the BG pattern, thus resulting in changing occlusions of BG pixels varying from BN to BN to reduce the occlusion, an exemplarily implementation may include the following:
Identify those FG print layers and their graphical patterns disturbing the estimation of BG references;
Create APD adaptions as to estimate the positions of the BG and relevant FG print layers
Create a binary FG mask for each FG print layer identifying the position of the contained patterns in normalized coordinate systems
For each imaged BN of the test-set:
   a) Transform that BN image into a normalized position, such that the offset print layer is aligned with its normalized reference system (e.g., provided as based on the APD);
   b. Transform each binary FG mask into the normalized BG reference system by means of APD, and accounting for the shift between FG and BG
   c. Overlay the binary FG masks on the transformed BN image and mark the pixels belonging to the FG as invalid in the transformed BN image;
Determining the desired BG reference from the transformed and masked BN images while ignoring in this calculation the BN specific invalid pixels
Calculating an estimate for those pixels in the BG reference where no statistics could be solved as those pixels were marked as invalid for all transformed BN images of the test set e.g. by classical extrapolation.

In the following, various more generic embodiments are detailed.

FIG. 1 illustrates a (e.g., multi-stage) printing process in a schematic process diagram 100 according to various aspects. A graphical reference layout 102 may include various graphical patterns, exemplarily including a background pattern 102a, a first foreground pattern 102b, and a second foreground pattern 102c. The graphical reference layout 102 may be provided as a superposition of multiple layout components 104a, exemplarily including a first layout component 104a including the background 102a, a second layout component 104b including the first foreground pattern 102b, and a third layout component 104c including the second foreground pattern 102c. It should be understood that, e.g., in a preferred embodiment, the background 102a fills the whole banknote and the one or more foreground pattern 102b overlay the background 102a, such that the blank regions shown for the first layout component 104a do not necessarily have to exist.

The graphical reference layout 102, e.g., each layout component thereof, may be supplied to a multi-stage printing device 110 including multiple printing device stages configured to print the graphical reference layout 102, e.g., each layout component thereof, on each of multiple sheets 112. As result thereof, the printing device 110 may output multiple printouts 114, of which each includes a sheet and a reproduction of the graphical reference layout 102 printed on the sheet 112.

In an example of a banknote as printout 114, the printing process may include multiple printing techniques, such as offset printing, intaglio printing, and/or security features printing, as examples. The offset printing may include transferring an inked image from a plate (also referred to as printing plate) to a rubber blanket as colorant carrier and then onto the note, which may be used to print the majority of the banknote (e.g., its background print layer, including one or more background images, texts, and other elements). The intaglio printing may include pressing an inked plate as colorant carrier onto the note, thereby creating a raised surface, which may be used to create the detailed images, such as portraits, and one or more security features (e.g., a watermark and/or a thread). Security feature printing may be used to add security features to the banknote, which may include a hologram, a UV-sensitive ink, and/or micro-printing as examples.

In some examples, the printing process may include overprinting. Overprinting may include printing a graphical pattern (e.g., including image and/or text) over a printed (already existing) a graphical pattern, e.g., layer-by-layer and/or using different printing plates. The ink used for overprinting is often a different color than the already applied print, which helps to make the overprinted text or image stand out.

Due to imperfections (e.g., misalignment) of the printing process, at least two printouts 114 may differ from each other in the position, at which a graphical pattern (then also referred to as positional-variable pattern) is printed, e.g., differ in the location and/or orientation thereof. Such imperfections may, for example, be based on variations on purpose, such as for the security thread.

As consequence, the positional relation of two printed graphical pattern of a printout 114 relative to each other may vary, which is illustrated in diagram 100a for the distribution n as function of the distance d as exemplarily positional relation. To facilitate the understanding, reference will be made to individual positional-variable patterns, of which each pattern is part of or forms a positional-variable layout component. If the positional-variable layout component includes two or more graphical patterns (which are positional invariant relative to each other), the references made to one of them as positional-variable pattern may apply in analogy to the whole layout component.

FIG. 2 illustrates multiple methods according to various embodiments in a schematic diagram 200, which are linked to a model 250 of the graphical reference layout (also referred to as modeled layout or as layout model), as detailed herein. The layout model 250 may implement multiple representations 250a, 250b, 250c, of which each representation represents a layout component (e.g., formed from one or more graphical patterns) of the graphical reference layout.

It may be understood that, although three representations 250a, 250b, 250c are shown as an example, the number of the multiple representations 250a, 250b, 250c may be more or less than three. In view thereof, herein reference will be made also to two representations 250a, 250b, 250c as an example, wherein the references made thereto may apply in analogy to more than two representations 250a, 250b, 250c.

A first method 300 is configured to determine the layout model 250 based on multiple printouts 114 (also referred to as set of printouts 114 or as test-set) of the graphical reference layout. A second method 700 is configured for assigning one or more printouts 114 to one out of multiple predetermined classes 280 (also referred to as classifying). The one or more printouts 114 supplied to method 300 may be, but do not need to be, a result from the printing process as shown in FIG. 1.

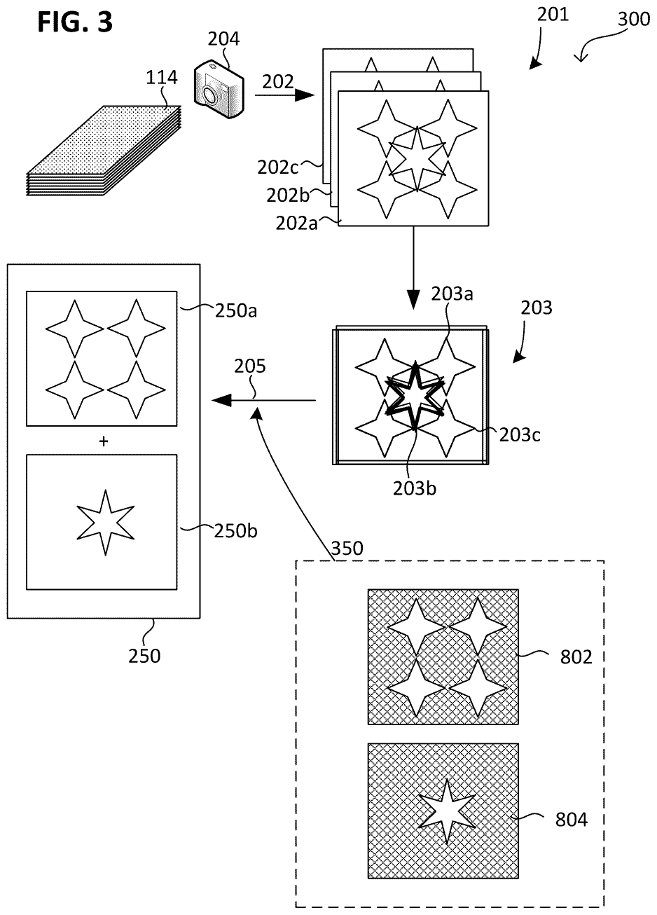

FIG. 3 illustrates the method 300 according to various embodiments in a schematic diagram, in which the printout 114 includes multiple printed graphical patterns, which are exemplarily in form of stars. The method 300 includes, in 201 (also referred to as pattern determination), determining (e.g., identifying) two or more graphical patterns (also referred to as positional-variable pattern) of the graphical reference layout 102, which fulfill a criterion for a printing related positional variation relative to each other, such that the references made to a positional-variable pattern of the a layout component may apply in analogy to the remaining graphical pattern of the layout component.

The pattern determination 201 may, in some aspects, based on a comparison 203 (also referred to as printout comparison 203) of multiple printouts 114, e.g., based on the result of imaging 202 the multiple printouts 114. The result of imaging 202 the multiple printouts 114 may include, for each printout of the multiple printouts 114, image data 202a, 202b, 202c of the printout 114 (also referred to as imaged printout 202a, 202b, 202c), of which working examples are presented in FIG. 4.

In some embodiments, the image data of each of the multiple printouts 114 may be sensed by the same imaging device 204. For example, the imaging device 204 may be part of a banking terminal or at least be of the same type as imaging device of the banking terminal. This increases the reliability of the layout model due to an increased data correlation.

The printout comparison 203 may include a comparison of the imaged printouts 202a, 202b, 202c with each other. As an illustrative example, a stack of the imaged printouts 202a, 202b, 202c is depicted, in which the imaged printouts 202a, 202b, 202c are positioned relative to each other, such that the upper right 4-tip-star 203a (as exemplary reference pattern) of each imaged printout 202a, 202b, 202c is arranged in a common position (also referred to as alignment). As visible from the stack, the position of the upper right 4-star 203a varies among the printouts relative to surrounding edge of the printouts and relative to the 6-tip-star 203b, but is invariant relative to the remaining 4-tip-stars. Based thereon, the 6-tip-star 203b and the group of 4-tip-stars may be determined by the printout comparison 203 as fulfilling the criterion for the printing related positional variation relative to each other.

Illustratively, the 6-tip-star 203b and the group of 4-tip-stars may be determined by the printout comparison 203 may be determined as a result of different printing process stages. For example, each of the group of 4-tip-stars may be determined as result of a first printing process stage of the multi-stage printing process and the 6-tip-stars may be determined as result of a second printing process stage of the multi-stage printing process.

The depicted stack of imaged printouts 202a, 202b, 202c may be understood as an example of a superposition of the imaged printouts 202a, 202b, 202c to perform the printout comparison 203. Other examples of the superposition may include any multi-input algorithm that is configured to map the imaged printouts 202a, 202b, 202c to a single superposition thereof. Such multi-input algorithm may include sub-algorithms, such as an alignment algorithm, a transparency algorithm, a pattern recognition algorithm, one or more image post-processing algorithms (e.g., for adding transparency, normalizing contrast, etc.) and the like. The superposition of the imaged printouts 202a, 202b, 202c may also be understood as an example component of the printout comparison 203, which facilitates the printout comparison 203. Additional or alternative implementations of the printout comparison 203 may be configured to determine, for each imaged printout 202a, 202b, 202c, the positional relation of each pattern relative to the other pattern as recognizable (e.g., by the pattern recognition algorithm) in the imaged printout 202a, 202b, 202c. Additional or alternative implementations of the printout comparison 203 may be based on one or more trained algorithms (e.g., including an artificial neural network or the like) and/or based on another type of machine learning algorithm. It may be understood that the artificial neural network is an example of a machine learning algorithm.

The method 300 includes, in 205 (also referred to as layout model determination 205), determining a layout model 250 for the graphical reference layout. The layout model determination is based on the result of the pattern determination 201, e.g., based on the determined graphical pattern, which fulfills a criterion for the printing related positional variation relative to each other, and/or based on the determined position thereof.

The printing model 250 implements, for each of the graphical pattern, a representation 250a, 250b (e.g., a modeled layout component) of the graphical reference layout (also referred to as print layer representation), of which each relates to an individual printing process stage and thus misses at least one graphical pattern. For example, the printing model 250 implements a first print layer representation 250a for printing the group of 4-tip-stars, which misses the 6-tip-star, and a second print layer representation 250b for printing the 6-tip-star, which misses the group of 4-tip-stars. As an example, each print layer representation 250a, 250b may include image data of the graphical pattern based on the imaged printouts 202a, 202b, 202c, e.g., based on the superposition thereof. For example, each print layer representation may include an extract of the superposition.

In an exemplarily implementation, in which the printout 114 includes a background print layer and one or more foreground print layer, the pattern determination 201 may include determining (e.g., identifying), based on the multiple printouts 114, of one or more foreground print layers and/or one or more printed graphical patters thereof. For example, the pattern determination 201 may include determining only those printed components (e.g., one or more foreground print layers and/or one or more graphical patters) of the printouts 114, which disturb determining the background representation.

Optionally, the determination of each print layer representation 250a, 250b may include, masking 350 one or more graphical pattern, e.g., by one or more masks 802, 804 (see also FIG. 5). For example, the method 300 may include, determining, for each positional-variable graphical pattern as resulting from the pattern determination 201, determining a mask 802, 804, which indicates the positional-variable graphical pattern as to be masked. The determination of a first print layer representation 250a, in which the 6-tip-star 203b as exemplarily first positional-variable graphical pattern is masked, may be based on a first mask 804, which indicates the 6-tip-star 203b as to be masked, and one or more of the imaged printouts 202a, 202b, 202c. The same may apply to one or more second print layer representations 250b, 250c. In an exemplarily implementation thereof, one or more imaged printouts 202a, 202b, 202c (e.g., a superposition thereof) may be superposed by the first mask 804 to mask the first positional-variable graphical pattern and/or to reveal one or more second positional-variable graphical pattern (here the group of right 4-star 203a as example).

It may be understood that the positional variation of a foreground graphical pattern (here 6-tip-star 203b as example) allows for determining a larger area of the print layer underlying the foreground graphical pattern, e.g., of the background print layer. In this case, only a part of the foreground graphical pattern is masked or at least marked, such that the total area, which is masked or at least marked, is less than the total area of the foreground graphical pattern. This allows for determining a larger portion of the underlying print layer, which increases the reliability of layout model 250. For example, a fraction of the background print layer, which is hidden by the security threat of a first banknote, may be visible for a second banknote due to the positional variation of the security threat.

FIG. 4 illustrates image data 202 of multiple banknotes as examples of printouts 114 according to various embodiments in a schematic view 400, in which arrows indicate printing related positional variations of printed foreground pattern among the banknotes, e.g., relative to the background print layer as positional reference. For this exemplary banknotes, one or more foreground print layers were printed by intaglio print, using optically variable ink (OVI), and included a foil/security thread, whereas the background print layer was printed using offset print. The visible moiré pattern is an artifact of the imaging process and may be suppressed by the usage of as sensor of higher pixel density.

FIG. 5 illustrates multiple masks 802, 804, 806 (also referred to as image processing masks) in a schematic view 500, which are used to determine (also referred to as background representation determination) a representation of the background layout component (also referred to as background print layer representation), in which the graphical patterns of the remaining foreground layout components are masked.

The background representation determination may include determining, for each print layer of the printout 114, a positional reference (e.g., an anchor-point) of the print layer (e.g., e.g., expressed as coordinates) thereof based on the printout 114, e.g., based on image data thereof. For example, the position of the positional reference of the print layer on the printout 114 may be determined as print position of the print layer. It may be understood that determining the print position may be one example of determining the printing related positional variation, which may, additionally or alternatively, determined as positional relation using another printing layer as positional reference.

This facilitates to determine the positions of the background print layer and one or more foreground print layers. The background representation determination may further include determining, for each foreground print layer, a (monochrome, e.g., binary) mask 802, 804, 806 (then also referred to as foreground mask) and/or a position thereof based on the positional reference of the foreground print layer. Each foreground mask 802, 804, 806 may indicate the position of one or more (e.g., each) graphical pattern of the foreground print layer, e.g., expressed as coordinates and/or in a normalized coordinate system.

The background representation determination may further include, for each printed exemplar of the banknote (e.g., based on image data thereof), transforming the image data of the printed banknote (e.g., the banknote image) into a normalized position, such that the background print layer (e.g., being an offset print layer), e.g., the positional reference thereof, is aligned with the normalized coordinate system, e.g., defined by the positional references; transforming each (e.g., binary) foreground mask 802, 804, 806 into the normalized coordinate system based on the positional references (e.g., anchor-points), which may account for the printing related positional variation between background print layer and the one or more foreground print layers; and masking the result of transforming the image data (also referred to as positional-normalized banknote image) based on the result of the transforming each (e.g., binary) foreground mask 802, 804, 806 (also referred to as positional-normalized foreground mask 802, 804, 806).

For example, masking the positional-normalized banknote image may include, e.g., for each of the foreground masks, superposing (e.g., overlay) the positional-normalized banknote image with the foreground mask and, based on the result thereof, marking the pixels of the foreground print layer, which are revealed by foreground mask, as invalid in the positional-normalized banknote image (e.g., by removing the respective pixels from the positional-normalized banknote image).

The background representation determination may include: determining the representation of the background layout component based on the result of masking the positional-normalized banknote image (also referred to as positional-normalized and masked banknote image), while ignoring, for each positional-normalized and masked banknote image, the masked components (e.g., pixels) of the positional-normalized and masked banknote image.

The background representation determination may include: determining an estimate for those pixels in the representation of the background layout component, for which no statistics could be solved as those pixels were masked (e.g., marked as invalid), for each positional-normalized banknote and masked banknote image. The resulting estimate may be determined, e.g., by classical extrapolation based on adjacent valid estimates and/or a deep learning based algorithm.

It may be understood that the aspects detailed above for the background print layer may be applied analogously to one or more foreground print layer.

FIG. 6 illustrates a schematic view 600 of two exemplary results 902, 904 of masking a positional-normalized banknote image (e.g., together with statistics calculation per pixel), of which one result (or a superposition of both result) may be determined as background print layer representation.

Comparing the results 902, 904 having an appropriate masking of the occluded banknote parts with the blurred ones in view 900 reveals that:
the modelled background print layer is free from artefacts caused by foreground objects, i.e., only those areas where a foreground will be located definitely in a real banknote is not part of the background reference;
some foreground graphic pattern may be even eliminated completely, such as the foil/security thread in the median reference (see 902).

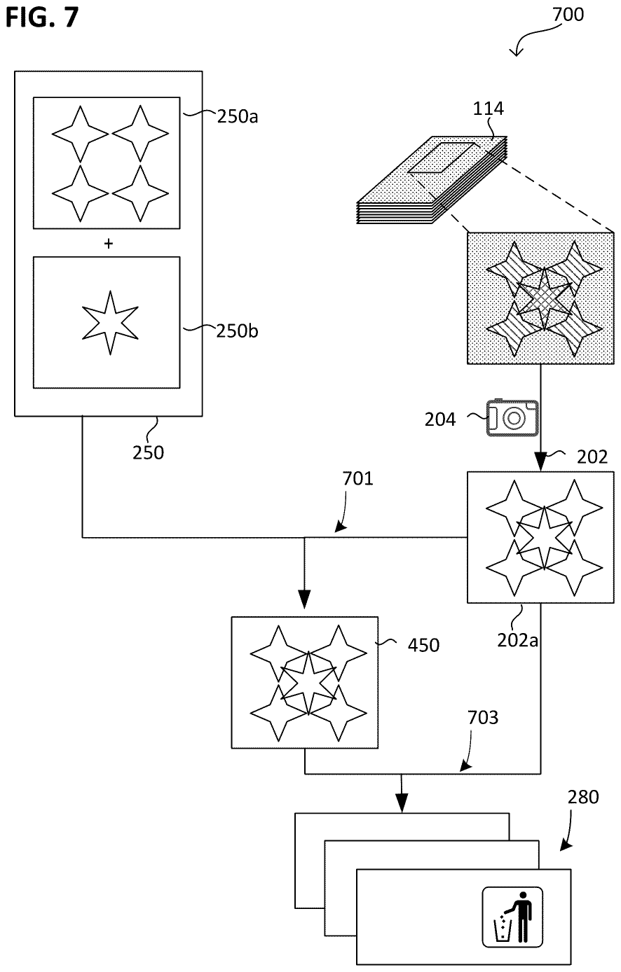

FIG. 7 illustrates the method 700 according to various embodiments in a schematic diagram, in which the one or more printouts 114 include multiple printed graphical pattern, which are exemplarily in form of stars. The method 700 includes, in 701 (also referred to as modelling the reproduction), determining a model 450 (also referred to as reproduction model 450) of a printout 114. Modelling 701 the reproduction may be based on the result of imaging 202 the printout 114, e.g., including an imaged printout 202a. Preferably, the imaged printout 202a may be sensed by an imaging device 204 of a constructional type, on which the layout model 250 is based.

The reproduction model 450 is based on the layout model 250, which implements the multiple print layer representations 250a, 250b (e.g., including a background print layer representation and one or more foreground print layer representations), of which each print layer representation represents at least one positional-variable pattern and/or which differ from each other in at least one positional-variable pattern as represented thereby.

The reproduction model 450 may be based on, for each print layer representation of the multiple print layer representations 250a, 250b, a position on the printout 114, at which the graphical pattern (e.g., the anchor point thereof) represented by the print layer representation is printed. For example, modelling 701 the reproduction may include determining, for each printed graphical pattern of the printout 114, a position of the printed graphical pattern as print position, e.g., expressed in coordinates and/or expressed as positional relation to a positional reference on the printout 114 (e.g., an anchor point or another printed graphical pattern). Additionally or alternatively, modelling the reproduction 701 may include positioning each print layer representation 250a, 250b based on the printout 114, e.g., based on image data 202 of the printout 114 and/or the print position.

The method 700 includes, in 703 (also referred to as classification), classifying the printout 114 based on the reproduction model 450, e.g., based on a comparison of the (e.g., imaged) printout 202a with the reproduction model 450. For example, the reproduction model 450 may be used as a reference for the classification, to which the printout 114 may be compared.

For example, the classification 703 may be based on a comparison of the printout 114, e.g., the image data 202a thereof, and the reproduction model 450. For example, the classification 703 may be based on one or more deviations of the printout 114, e.g., the image data 202a thereof, from the reproduction model 450, e.g., determined based on the comparison thereof.

In an exemplarily implementation, the reproduction model 450 may represent the reference state of the printout 114 as a result of a multi-stage printing process, e.g., taking into account the printing related positional variations of the multi-stage printing process (e.g., at the circumstances under which the printout was output by the multi-stage printing process). The reference state may deviate from the actual state of the printout 114, e.g., due to the usage of the printout 114. The one or more deviations may indicate the change from the reference state to the actual state, e.g., indicating contamination, damage, visible signs of usage, and/or lost parts of the printout 114.

As an example, the classification 703 may be implemented by a stain-and graffiti-detection algorithm (SGD), which is configured for detecting stains and graffiti, especially in printed banknote areas, based on the reproduction model 450. In this exemplarily implementation, the result of the classification 703 may represent, whether the printout 114 is acceptable, e.g., for further usage, or not.

In case of a printout 114 of a banknote, the layout model 250 may be selected from multiple layout models, which differ from each other in the type of banknote they represent, e.g., differ from each other in a denomination of the banknote, in the authority that issued the banknote, in the currency system of the banknote, and the like.

In the following, additional working examples according to various embodiments are detailed based on printed banknotes as examples of printouts 114. In context to banknotes, the reproduction model 450 may be also referred to as banknote model 450 (BNM), the graphical reference layout may be also referred to as banknote reference layout, the graphical pattern may include a banknote background pattern; a graphical representation (e.g., number) of the denomination of the banknote (e.g., as banknote foreground pattern); one or more graphical security feature of the banknote (e.g., as banknote foreground pattern); an identification number of the banknote (e.g., as banknote foreground pattern); and/or a pictorial element (e.g., as banknote foreground pattern), e.g., including portrait, landscape and the like.

FIG. 8 illustrates multiple banknote models 450 according to various embodiments in a schematic view 800, which are determined based on the layout model 250 and differ from each other in the underlying print exemplar of the banknote, e.g., representing median models of three different banknote images. The banknote model 450, e.g., for the stain- and graffiti detection algorithm, may be generated individually for each print exemplar of the banknote, e.g., as the positional relation of one or more print layers and/or one or more security features may vary from banknote to banknote.

In an exemplary working example, the determination of the banknote model 450 (e.g. for the minimum or mean or median or maximum expected banknote gray-scale image 202a) may, for each print exemplar of a banknote, include: selecting a print layer representation 250a (e.g., in which one or more foreground pattern are marked) as background reference; overlaying one or more print layer representations 250b, 250c (e.g., in which one or more background pattern are marked) as corresponding foreground references one after another over the background reference as to successively build up the banknote model 450 of the print exemplar; wherein the overlaying may optionally include a positioning of each foreground reference relative to the background reference, e.g., based on the print exemplar (e.g., the positional variation determined therefrom); optionally determining (e.g., marking) one or more disturbances of the banknote model 450 as to be (e.g., completely) masked.

For example, the position of each individual foreground reference in the banknote model 450 may be determined, e.g., by adjustment based on the estimated positions of their corresponding print layers relative to the background print layer (or to another positional reference). Examples of the disturbances may have a position being invariant regarding the printing process (e.g., such as the printout edge) or a position being a function of the printing process (e.g., such as a security thread). The printout edge may be a physical edge (e.g., a fraction of the circumference) of the printout.

For some or most currencies, details of the graphical reference layout and/or multi-stage printing process for the banknote are non-public knowledge. For example, the layout of the printing plate for the offset print may be unknown, which complicates the determination of the offset print layer as background reference. For such cases, the aspects as detailed herein allow for the determination of a more accurate layout model 250 (e.g., and the print layer representations 250a, 250b thereof), and thus allow for the determination of a more accurate BNM 450. As to be able to overlay background and foreground references with varying positions, a background reference for the whole banknote is determined. In such cases, the individual layout components may be determined (e.g., by reconstruction, learning and/or estimation) based on available printed exemplars of the banknote.

FIG. 9 illustrates, to facilitate the understanding, a comparative examples of the superposition according to various embodiments in a schematic view 900, in which a median superposition for CNY100d background (offset print, 100 dpi, G channel) and of a minimum superposition for CNY100d background (offset print, 100 dpi, G channel) is depicted, wherein the printing related positional variation was set to zero. The multiple banknote printouts 114 may include exemplars of common denomination and common currency system, of which each is sensed to provide multiple banknote images as imaged printouts 202a, 202b, 202c.

In the comparative examples, the superposition includes: transforming each banknote image 202a into a positional-normalized banknote image, which have the position of the offset print layer in common (e.g., by aligning the offset print layer to each other); solving, for each pixel of the positional-normalized banknote image, the desired value from the positional-normalized banknote images to calculate the desired minimum or mean or median or maximum reference. This uniform positional normalization may result in acceptable result for the median reference and/or a less complex banknote reference layout, such as the reverse side of EUR banknotes as example, which consists of a single print layer as banknote background. In case of a more complex banknote reference layout, see for example the front side of EUR or CNY banknotes or the reverse side of CNY banknotes, the uniform positional normalization may produce a banknote model 450 with blurred areas due to printing related positional variations. For example, the position on the printout, at which each foreground graphical pattern is printed, relative to the background may be a function of the exemplar of the printout. For example, the printing related positional variations may result in changing occlusions of background pixel snippets varying from exemplar to exemplar of the banknote.

It is noted that, the higher the printing related positional variation is, the more information of a graphical (e.g., background) pattern may be determined based on the multiple printouts 114. Illustratively, parts of the graphical (e.g., background) pattern, which are overprinted on one printout (e.g., printed exemplar of the banknote), may be visible on another printout (e.g., printed exemplar of the banknote). This information may be contained in the layout model 250, e.g., at least in the print layer representation, in which the graphical (e.g., background) pattern is non-masked. As exemplarily result, the total masked area of the layout model 250 may be less than 100%, and/or at least one graphical pattern is masked partially (not completely) by the print layer representation, in which the graphical background pattern is non-masked.

FIG. 10 illustrates a banking terminal 1000 according to various embodiments in a schematic view and components thereof, which are coupled communicatively to each other (e.g., via a data interface of the respective component) as indicated by arrows, e.g., via a network.

The banking terminal 1000 may include a human-machine-interface 1004, e.g., including a cash transfer device 1004a (e.g., configured for receiving cash from the human and/or dispensing cash to the human), a keyboard 1004b (e.g., for receiving instructions from the human) and a display 1004c (e.g., for presenting information to the human). The banking terminal 1000 may further include a cash storage device 1008 (e.g., including a safe and/or one or more cash storing cassettes) for storing cash (e.g., banknotes), which are received and/or dispensed by the banking terminal 1000, e.g., via the human-machine-interface 1004. The banking terminal 1000 may further include a transport device 1012 for transporting cash between (e.g., to and/or from) the cash storage device 1008 and the human-machine-interface 1004.

The banking terminal 1000 may further include an imaging device 1006 configured to sense cash (e.g., one or more banknotes), e.g., received by the banking terminal 1000, e.g., via the human-machine-interface 1004. For example, the imaging device 1006 may be configured to sense cash transported by the transport device 1012.

The banking terminal 1000 includes further a control device 1002 and one or more components thereof, which do not necessarily have to be physically disposed within a housing 1010 of the banking terminal 1000, e.g., when the control device 1002 or one or more components thereof are provided at least partially via cloud computing, as common computing system of multiple banking terminals 1000, as remote controlling device, or the like. The control device 1002 may be configured to control one or more of the following components (e.g., via the data interface of the respective component): the imaging device 1006, the cash storage device 1008, the human-machine-interface 1004, and/or the transport device 1012.

The control device 1002 may include at least one (one or more) processor 1002a and/or at least one memory 1002b, e.g., storing code segments (e.g., provided as bit-string) that include instructions according to one or more methods detailed herein, e.g., method 300 and/or method 700. The instructions may be configured to, when executed by at least one processor 1002a, direct the at least one processor 1002a perform the one or more methods detailed herein, e.g., method 300 and/or method 700. Additionally or alternatively, one or more of the following may be stored by the at least one memory 1002b: the sharpness criterion, the criterion for a printing related positional variation, one or more layout models 250, image data, one or more predefined classes.

For example, the control device 1002 may be configured to receive image data of a banknote (e.g., received via the cash transfer device 1004a) from the imaging device 1006, and determine the reproduction model 450 based thereon. Further the control device 1002 may be configured to classify the banknote and, in accordance with the result of the classification, instruct a rejection of the banknote and/or storage of the banknote in the cash storage device 1008 (e.g., in a respective cash cassette thereof).

Additionally or alternatively, the control device 1002 may be configured to receive image data of one or more banknotes (e.g., received via the cash transfer device 1004a) from the imaging device 1006, and determine (e.g., update) the layout model 250 based thereon. This reduces the need for maintenance. For example, the control device 1002 may be configured to determine a change in one or more optical properties of the imaging device 1006 based on the image data and update the layout model 250 based on the change. This allows to compensate for the change at least partially and thus enhances the lifetime of the banking terminal 1000. Additionally or alternatively, the control device 1002 may be configured to determine a new layout model 250 from the scratch based on the image data. This facilitates to adapt the banking terminal 1000 to changes in the banknote design and/or currency system (e.g., in normal operation), or allows an operator to set up a new banking terminal 1000 without the help of the manufacturer.

As an example, updating the layout model 250 may be beneficial for a case, in which the layout model 250 was initially determined based on a set of (e.g., 100) banknotes and is later determined to be inadequate, e.g., as modelling 700 one or more (e.g., 10000) further banknotes reveals that the number of banknotes in the set of banknotes as to less to obtain an appropriate layout model 250. In such case, the layout model 250 may be updated based on the image data of the further banknotes as determined during modelling 700 the further banknotes.

As another example, updating the layout model 250 may be beneficial for a case, in which the printing process had changed, e.g., by a change of the colorant. In such case, the layout model 250 may be updated based on the image data of further results of the changed printing process during modelling 700 the results of the changed printing process.

FIG. 11 illustrates multiple banknote models 450 according to various embodiments in a schematic view 1100 in analogy to view 800, wherein additionally one or more (e.g., banknote individual) graphical patterns (e.g., security features) are masked. Examples of the banknote individual pattern may include: an identification number, a serial number, and/or a security threat. Masking parts of the banknote model allows for maximizing the reliability of the classifying, e.g., as banknote individual variations are minimized. As visible for the security threat as example, the banknote individual position of the mask may optionally be a function of the printing related positional variation of the position of the security threat. This allows for further maximizing the reliability of the classifying.

It may be understood that such mask (e.g., its geometry and/or position) may be determined in analogy to the above, e.g., based on the printing related positional variation. Additionally or alternatively, the representation of one or more print layers may be manually modified, e.g. when the available reproductions vary too much as in the case of an Optically Variable Ink (OVI), where it can be better to mask the area during detection.

In the following, various examples are provided with reference to the aspects described above.

Example 1 is a method, comprising: determining two or more graphical patterns of a graphical reference layout, which fulfill a criterion for a printing related positional variation relative to each other, based on (e.g., a comparison of) multiple printed reproductions of the graphical reference layout; and determining (e.g., generating or updating) a model of the graphical reference layout based on a result of the determining the two or more graphical patterns, wherein the model implements, for each graphical pattern of the two or more graphical patterns, a (e.g., separate and/or partial) representation of (e.g., a result of printing) of the graphical reference layout, according to which the graphical pattern (e.g., completely or only a part thereof) is masked (e.g., by a preset color value) or at least marked (e.g., by a preset color value).

Example 2 is the method of example 1, wherein the result of the determining the two or more graphical patterns includes the positional variation of two or more graphical patterns as reproduced by the printed reproductions.

Example 3 is the method of example 1 or 2, wherein determining the two or more graphical patterns includes determining that the two or more graphical patterns fulfill the criterion and/or determining the positional variation of two or more graphical patterns as reproduced by the printed reproductions.

Example 4 is the method of one of examples 1 to 3, wherein the two or more graphical patterns are determined based on the criterion.

Example 5 is the method of one of examples 1 to 4, wherein the criterion for the printing related positional variation is stored (e.g., on a storage medium) and/or invariant for each of the reproductions.

Example 6 is the method of one of examples 1 to 5, wherein the determining (e.g., the model of the graphical reference layout and/or the two graphical patterns) and/or the comparison are based on (e.g., an image based superposition of) the multiple printed reproductions (e.g., image data thereof) and/or based on (e.g., a superposition of) image data of (e.g., each of) the multiple printed reproductions, wherein preferably the image data results from sensing the multiple printed reproductions optically.

Example 7 is the method of one of examples 1 to 6, wherein the representation is based on (e.g., each of) the multiple printed reproductions (e.g., image data thereof) and/or based on (e.g., a superposition of) image data of (e.g., each of) the multiple printed reproductions, wherein preferably the image data results from sensing the multiple printed reproductions optically.

Example 8 is the method of one of examples 1 to 7, wherein the comparison is based on first image data of a first printed reproduction of the multiple printed reproductions and second image data of a second printed reproduction of the multiple printed reproductions; wherein, preferably, the comparison is based on at least one superposition (e.g., multiple superpositions) of the first image data and second image data, of which each superposition is a function of the positional variation.

Example 9 is the method of example 8, wherein the at least one superposition of the first image data and second image data comprise a first superposition and a second superposition, which differ from each other in a positional relation of the first image data and/or second image data, in which they are superposed.

Example 10 is the method of one of examples 1 to 9, wherein the comparison is based on a (e.g., optical) superposition of the multiple printed reproductions, e.g., image data thereof; and/or wherein the criterion for the printing related positional variation is fulfilled, when the superposition of the multiple printed reproductions, e.g., of image data thereof (e.g., of the first image data and second image data), changes a sharpness of the printed graphical patterns (e.g., relative to the image data).

Example 11 is the method of one of examples 1 to 10, wherein the criterion for the positional variation is fulfilled, when the positional variation among the multiple printed reproductions exceeds a threshold.

Example 12 is the method of one of examples 1 to 11, wherein the result of the determining the two or more graphical patterns includes the positional variation of the two or more graphical patterns, e.g., among the multiple reproductions and/or in relation to a positional reference (e.g., of the graphical reference layout), wherein the positional reference may be determined by an anchor-point detection.

Example 13 is a method (e.g., the method of one of examples 1 to 12), comprising: determining a model of a printed reproduction of a graphical reference layout, wherein the graphical reference layout includes two or more graphical patterns, wherein the model of the printed reproduction is based on a model of the graphical reference layout comprising, for each graphical pattern of two or more graphical patterns, a (e.g., separate and/or partial) representation of (e.g., a result of printing) of the graphical reference layout, according to which (e.g., by which) the graphical pattern (e.g., completely or only a part thereof) is masked (e.g., by a preset color value) or at least marked (e.g., by a preset color value); and classifying the printed reproduction based on the model of the printed reproduction and preferably on the printed reproduction (e.g., image data thereof), e.g., based on a comparison of the model of the printed reproduction and the printed reproduction.

Example 14 is the method of example 13, wherein determining the model of the printed reproduction is based on image data of the printed reproduction, preferably being a result of sensing the printed reproduction optically and/or by an imaging device of a constructional type, on which the model of the graphical reference layout is based.

Example 15 is the method of one of examples 13 or 14, further comprising: determining a change in one or more optical properties of the imaging device; and updating the layout model based on the change, preferably to compensate for the change at least partially.

Example 16 is the method of one of examples 13 to 15, further comprising: selecting the model of the printed reproduction from multiple predetermined models of the printed reproduction, e.g., based on the printed reproduction (or based on image data thereof).

Example 17 is the method of one of examples 13 to 16, wherein the model of the printed reproduction is based on a position, at which each of the at least two or more graphical patterns is reproduced on the printed reproduction of the graphical reference layout.

Example 18 is the method of one of examples 13 to 17, wherein the model of the graphical reference layout includes a multiple (e.g., a stack) of the representation, wherein the determining the model of the printed reproduction includes determining a positional relation of the multiple (e.g., a stack) of the representation relative to each other (e.g., in which they are combined, e.g., by superposition, to the model of the graphical reference layout) based on a position, at which each of the at least two or more graphical patterns is reproduced on the printed reproduction of the graphical reference layout.

Example 19 is the method of one of examples 13 to 18, wherein the classifying the printed reproduction may be based on one or more deviations of the printed reproduction from the model of the printed reproduction, e.g., determined based on the comparison thereof.

Example 20 is the method of one of examples 13 to 19, wherein the classifying the printed reproductions includes assigning the printed reproduction to a conditional state (e.g., fitness for further usage) representing class.

Example 21 is the method of one of examples 13 to 20, wherein the classifying the printed reproductions uses a stain-and graffiti-detection algorithm.

Example 22 is the method of one of examples 13 to 21, wherein the classifying the printed reproductions includes assigning the printed reproduction to one class from a group of classes, which differ from each other in a conditional state represented thereby.

Example 23 is the method of one of examples 1 to 22, wherein two or more graphical patterns include at least graphical background pattern and/or at least one graphical foreground pattern.

Example 24 is the method of one of examples 1 to 23, wherein the model of the graphical reference layout includes a multiple (e.g., a stack) of the representation, which, preferably, are separate (e.g., independent and/or distant) from each other, e.g., regarding their position, and/or which, preferably, differ from each other in the graphical pattern, which is masked therein.

Example 25 is the method of example 24, wherein the multiple of the representation of the graphical reference layout include a first representation, in which at least one first graphical pattern (e.g., a foreground graphical pattern) of the two or more graphical patterns is masked, and a second representation, in which at least one second graphical pattern (e.g., a background graphical pattern) of the two or more graphical patterns is masked, wherein preferably, the at least one first graphical pattern and the at least one second graphical pattern differ from each other (e.g., in at least on graphical pattern and/or the position, in which they are masked).

Example 26 is the method of one of examples 1 to 25, wherein the model of the graphical reference layout represents a multi-stage printing process, preferably used for reproducing the graphical reference layout, e.g., for printing the or each reproduction of the graphical reference layout.

Example 27 is the method of one of examples 1 to 26, wherein the graphical pattern is masked by a part of the (e.g., pixels of the) representation, which represents the position of the graphical pattern and/or which is set to a preset color value.

Example 28 is the method of one of examples 1 to 27, wherein the model of the graphical reference allows for (e.g., implements) the positional variation of the representation.

Example 29 is the method of one of examples 1 to 28, wherein the or each reproduction(s) is/are provided as (e.g., physically) printed matter and/or sensed optically.

Example 30 is the method of one of examples 1 to 29, wherein the or each representation of the graphical reference layout, in which the graphical pattern is masked, indicates a position, at which the graphical pattern is masked, wherein the position is preferably based on the printing related positional variation and/or based on the or each printed reproduction.

Example 31 is the method of one of examples 1 to 30, wherein the or each reproduction is a result of multiple printing processes, preferably of which at least one first printing process includes offset printing and of which at least one second printing process includes intaglio printing.

Example 32 is the method of one of examples 1 to 31, wherein the determining the model of the printed reproduction includes, for each graphical pattern of two or more graphical patterns, determining a positional transformation of the representation of the graphical reference layout, according to which (e.g., by which) at least a part of the graphical pattern is masked (e.g., masked out) or at least marked, based on the position.

Example 33 is the method of one of examples 1 to 32, wherein each of the multiple printed reproductions of the graphical reference layout is a result of a multi-stage printing process, preferably represented by the model of the graphical reference layout.

Example 34 is the method of one of examples 1 to 33, wherein the model of the graphical reference layout includes a multiple of the representation, of which each representation is based on a superposition of the multiple printed reproductions, preferably of image data of (e.g., each of) the multiple printed reproductions.

Example 35 is the method of one of examples 1 to 34, wherein the graphical pattern is masked using an image processing mask, wherein the mask is based on the multiple printed reproductions, preferably on image data of (e.g., each of) the multiple printed reproductions, more preferably on a superposition of the image data.

Example 36 is the method of one of examples 1 to 35, wherein the two or more graphical patterns include one or more of the following graphical pattern: a graphical background; a graphical representation of a denomination; a graphical security feature; an identification number; a pictorial element.

Example 37 is the method of one of examples 1 to 36, wherein the graphical reference layout is a banknote reference layout.

Example 38 is the method of one of examples 1 to 37, wherein the representation is based on a superposition of first image data of a first printed reproduction of the multiple printed reproductions and second image data of a second printed reproduction of the multiple printed reproductions.

Example 39 is the method of one of examples 1 to 38, wherein the model of the graphical reference layout implements, for each of the two or more graphical pattern, a graphical representation of the graphical pattern (preferably determined based on image data of the multiple printed reproductions) being non-masked.

Example 40 is one or more non-transitory computer-readable media storing instructions thereon that, when executed by at least one processor, direct the at least one processor perform the method of examples 1 to 39.

Example 41 is a control device (e.g., implemented by one or more processors), which is configured to perform the method of examples 1 to 39, preferably comprising the one or more non-transitory computer-readable media of example 40.

Example 42 is a banking terminal comprising the control device of example 41.

Example 43 is the banking terminal of example 42, further comprising: an imaging device, wherein the model (e.g., of the printed reproduction and/or of the graphical reference layout) is based on image data of the graphical reference layout and/or of one or more printed reproductions of the graphical reference layout sensed by the imaging device.

Example 44 is using a model of a graphical reference layout (e.g., a banknote reference layout), which includes two or more graphical patterns, for determining a model of a printed reproduction of a graphical reference layout, wherein the model implements, for each graphical pattern of the two or more graphical patterns, a representation of the graphical reference layout, according to which at least a part of the graphical pattern is masked (e.g., masked out) or at least marked.

Example 45 is using multiple printed reproductions (e.g., image data thereof) of a graphical reference layout (e.g., a banknote reference layout), which includes two or more graphical patterns, for determining a model of the graphical reference layout, wherein the model of the graphical reference layout implements, for each graphical pattern of the two or more graphical patterns, a representation of the graphical reference layout, according to which at least a part of the graphical pattern is masked (e.g., masked out) or at least marked.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

What is claimed is:

1. A method, comprising:
determining (201) two or more graphical patterns of a graphical reference layout (102), which fulfill a criterion for a printing related positional variation relative to each other, based on multiple printed reproductions (114) of the graphical reference layout (102);
wherein the graphical patterns are positional-variable patterns;
wherein the graphical reference layout (102) is a print layer representation;
determining (205) a layout model (250) of the graphical reference layout (102) based on a result of the determining (201) the two or more graphical patterns, wherein the layout model (250) implements, for each graphical pattern of the two or more graphical patterns, a modeled layout component (250a, 250b, 250c) of the graphical reference layout (102), according to which at least a part of the graphical pattern is masked or at least marked, wherein each modeled layout component (250a, 250b, 250c) relates to an individual printing process stage and thus misses at least one graphical pattern;
determining a reproduction model (450) of the printed reproduction (114) of the graphical reference layout (102), wherein the graphical reference layout (102) includes the two or more graphical patterns, wherein the reproduction model (450) of the printed reproduction (114) is based on the layout model (250) of the graphical reference layout (102) comprising, for each graphical pattern of two or more graphical patterns, the modeled layout component (250a, 250b, 250c);
classifying (280) the printed reproduction (114) based on the printed reproduction (114) and on the reproduction model (450) of the printed reproduction (114).

2. The method of claim 1, wherein the determining (201) the two or more graphical patterns is based on a comparison (203) of the multiple printed reproductions (114) with each other and/or based on image data of the multiple printed reproductions (114).

3. The method of claim 1 or 2, wherein the graphical pattern is masked using an image processing mask (802, 804), wherein the mask (802, 804) is based on the multiple printed reproductions (114), preferably on image data of each of the multiple printed reproductions (114).

4. The method of one of claims 1 to 3, wherein the result of the determining (201) the two or more graphical patterns includes the positional variation of the two or more graphical patterns, preferably in relation to a positional reference of the graphical reference layout.

5. The method of one of claims 1 to 4, wherein the layout model (250) of the graphical reference layout (102) includes a multiple of the modeled layout component (250a, 250b, 250c), of which each representation is based on a superposition of the multiple printed reproductions, preferably of image data of each of the multiple printed reproductions (114).

6. The method of claim 1, wherein the determining the reproduction model (450) of the printed reproduction (114) is based on image data of the printed reproduction (114).

7. The method of one of claims 1 to 6, wherein the reproduction model (450) of the printed reproduction (114) is based on a position, at which each of the at least two or more graphical patterns is reproduced by the printed reproduction (114) of the graphical reference layout (102).

8. The method of claim 7, wherein the determining the reproduction model (450) of the printed reproduction (114) comprises, for each graphical pattern of two or more graphical patterns, determining a positional transformation of the representation of the graphical reference layout (102), according to which at least a part of the graphical pattern is masked or at least marked, based on the position, at which the graphical pattern is reproduced by the printed reproduction (114) of the graphical reference layout (102).

9. The method of one of claims 1 to 8, wherein the graphical reference layout (102) is a banknote reference layout.

10. The method of one of claims 1 to 9, wherein the two or more graphical patterns include one or more of the following graphical pattern:
a graphical background;
a graphical representation of a denomination;
a graphical security feature;
an identification number; and/or
a pictorial element.

11. One or more non-transitory computer-readable media storing instructions thereon that, when executed by at least one processor, direct the at least one processor perform the method of claims 1 to 10.

12. A control device (1002), which is configured to perform the method of claims 1 to 10, preferably comprising the one or more non-transitory computer-readable media of claim 11.

13. A banking terminal (1000) comprising the control device of claim 12.
